(19) United States
(12) Patent Application Publication
(10) Pub. No.: US 2012/0238151 A1
(43) Pub. Date: Sep. 20, 2012

(54) THIN PLUG CONNECTOR AND ASSEMBLY METHOD THEREOF

(76) Inventor: Pei-Chiao HUNG, New Taipei City (TW)

(21) Appl. No.: 13/423,713

(22) Filed: Mar. 19, 2012

(30) Foreign Application Priority Data
Mar. 18, 2011 (TW) 100109348

(51) Int. Cl. H01R 24/28; H01R 43/16

(52) U.S. Cl. 439/660; 29/874

(57) ABSTRACT

A thin plug connector includes an insulator body having a tongue plate protruding from one side thereof, and a pair of holding portions disposed on two opposite ends thereof. A plurality of terminals are disposed on the insulator body with each terminal including a contact portion disposed on the tongue plate and a soldering portion, wherein the soldering portion is disposed on a first side of the insulator body. A metallic casing covers the insulator body, and has a first opening to permit the tongue plate to extend through the first opening to expose the contact portions of the terminals. The first and second side plates respectively cover the first side and the second side opposite the first side. A pair of connecting plates connecting the first and second side plates blocks the holding portions to limit movement of the insulator body in the direction towards the first opening.

### CROSS-REFERENCE TO RELATED APPLICATION

This application claims priority of Taiwanese Patent Application No. 100109348, filed on Mar. 18, 2011.

### BACKGROUND OF THE INVENTION

1. Field of the Invention

This invention relates to a plug connector, and more particularly to a thin plug connector that is used in combination with a socket connector.

2. Description of the Related Art

With various types of electronic products becoming increasingly popular, the demand for connectors as essential connecting components among electronic products is also growing. Furthermore, as electronic products become lighter, thinner, and more portable, the size of the connectors is also becoming smaller, consequently raising the degree of difficulty in the manufacture and assembly of the connectors as a result.

Since the volume of signal communication between conventional liquid crystal displays (LCD) and system hosts is huge, with the frequency of communication high, present high frequency signal transmission systems provided in between LCD interfaces and system motherboard interfaces utilize low voltage differential signal (LVDS) receivers with high speed (1.4 Gb/s), low power consumption, and low electromagnetic radiation as the signal transmission interface of the LCD interface. By way of connecting through a transmission cable, the signal transmission interface of the LCD interface and the signal transmission interface of the system motherboard interface (i.e. a connector socket on the system motherboard interface) together form a signal connection to subsequently constitute the LVDS signal transmission system.

Referring to FIG. 1, a low voltage differential signal connector 9, as disclosed in Taiwanese Patent No. M374681, includes a metallic casing unit 91, an insulator body 92, and a plurality of terminals 93. The metallic casing unit 91 includes a top cover 911 and a bottom cover 912, wherein the insulator body 92 is installed between the top cover 911 and the bottom cover 912, and the terminals 93 are disposed on the insulator body 92. The top cover 911 and the bottom cover 912, separately manufactured, are then assembled together to cover the insulator body 92 therebetween.

### SUMMARY OF THE INVENTION

An object of the present invention is to provide a thin plug connector that has a simple structure and assembly process and a method of assembling thereof.

According to one aspect of the present invention, a thin plug connector includes an insulator body, a plurality of terminals disposed on the insulator body, and a metallic casing. The insulator body includes a tongue plate, a pair of holding portions, and a plurality of insert grooves. The tongue plate protrudes from one side of the insulator body. The pair of holding portions are provided on two opposite ends of the insulator body. Each terminal includes a contact portion and a soldering portion. The contact portion is disposed on the tongue plate while the soldering portion is disposed on a base of the insulator body. The metallic casing sleeves the insulator body and has a first opening, a first side plate, a second side plate opposite to the first side plate, and a pair of connecting plates connecting the first and second side plates at two opposite sides of the first opening. The first opening permits the tongue plate to protrude therethrough so that the contact portions of the terminals are exposed. The first and second side plates respectively cover the upper side and the lower side of the insulator body. The connecting plates block the holding portions of the insulator body to prevent the insulator body from moving in a direction toward the first opening.

The metallic casing further has a pair of bent plates connecting the first and second side plates, so that the metallic casing is formed as a slip-on sleeve with a rectangular cross section. The bent plates cover the holding portions.

The metallic casing is formed by bending and engaging a plate or a plurality of individual plates. The metallic casing further has a first engaging portion and a second engaging portion located respectively on the first side plate and the second side plate. The bent plates are bent from one of the first and second side plates toward the other of the two side plates so that the first and second engaging portions can engage each other. Prior to engagement of the first and second engaging portions, the first engaging portion protrudes out of the connecting plate. The first and second engaging portions are configured as grooves and protrusions.

Each bent plate has a finger piece at one side thereof. The finger pieces of the bent plates limit movement of the holding portions in the direction toward a second opening.

According to another aspect of the present invention, a method of assembling a thin plug connector includes forming the insulator body integrated with the terminals and assembling a metallic casing to the insulator body. The insulator body has a tongue plate, and a pair of holding portions provided on two opposite sides of the insulator body. The contact portion of each terminal is disposed on the tongue plate. The soldering portion of each terminal is disposed on a first side of the insulator body. The metallic casing has a first opening, a first side plate, a second side plate, and a pair of connecting plates. The tongue plate extends through the first opening so that the first and second side plates respectively cover the upper side and the lower side of the insulator body. The connecting plates block the holding portions of the insulator body to prevent the insulator body from moving in a direction toward the first opening of the metallic casing.

The metallic casing not only has a simple structure, but also can eliminate the assembly process of the conventional top and bottom covers. Further, the method of assembling the metallic casing to the insulator body is also simplified.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an exploded perspective view of a low voltage differential signal connector disclosed in Taiwanese Patent No. M374681;

FIG. 2 is an exploded perspective view of a thin plug connector according to the preferred embodiment of the present invention;

FIG. 3 is a bottom perspective view of a metallic casing of the preferred embodiment;

FIG. 4 is a plan view of a plate for making the metallic casing of the preferred embodiment;

FIG. 5 is a flow diagram illustrating the steps involved in a method of assembling the thin plug connector of the preferred embodiment;

FIG. 6 is an exploded perspective view of an insulator body and cables of the preferred embodiment;

FIG. 7 is a schematic view illustrating the metallic casing to be assembled with the insulator body;

FIG. 8 is an assembled perspective view of the metallic casing and the insulator body;

FIG. 9 is a sectional side view of FIG. 8; and

FIG. 10 is an assembled perspective view of the metallic casing and the insulator body taken from another angle.

### DETAILED DESCRIPTION OF THE PREFERRED EMBODIMENT

The above-mentioned and other technical contents, features, and effects of this invention will be clearly presented from the following detailed description of the preferred embodiments in conjunction with the reference drawings.

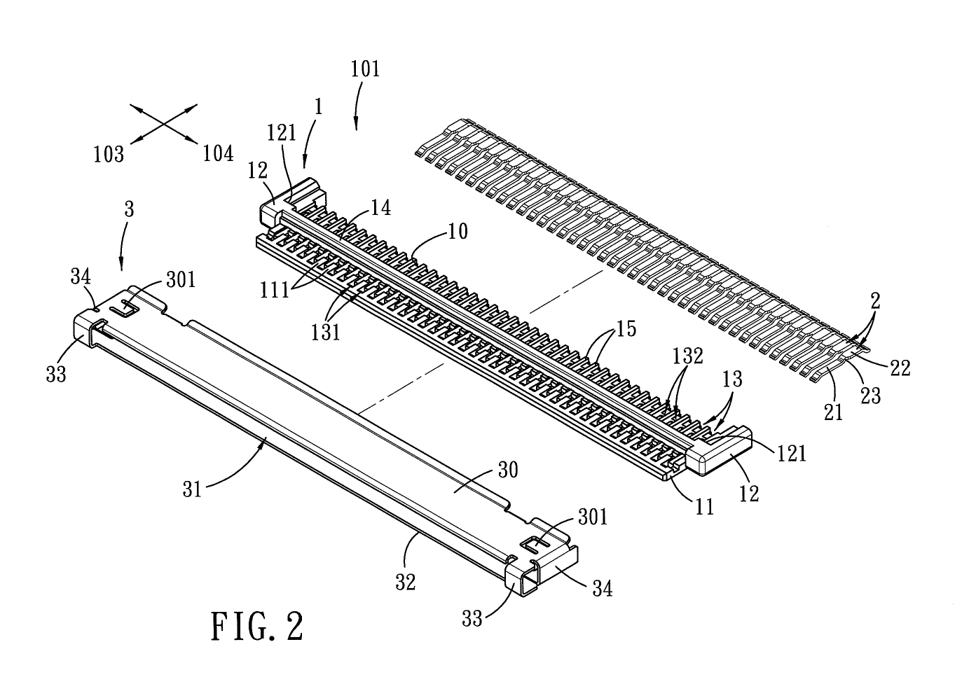

Referring to FIG. 2, a thin plug connector 101 of a preferred embodiment of the present invention is illustrated. In the present embodiment, the thin plug connector 101 is preferably a low voltage differential signal (LVDS) connector applied to products related to the field of computers, such as laptop computers, cellular phones, personal digital assistants (PDA), or any other suitable products in other fields.

The thin plug connector 101 includes an insulator body 1, a plurality of terminals 2, and a metallic casing 3. The insulator body 1 includes a base 10, a tongue plate 11, a pair of holding portions 12, a plurality of grooves 13, and a partition member 14. The tongue plate 11 protrudes from one side of the insulator body 1 along a first direction 103. Specifically, as shown in FIG. 2, the tongue plate 11 protrudes from one side of the base 10 along the first direction 103. The base 10 extends along a second direction 104, perpendicular to the first direction 103. The pair of holding portions 12 are disposed on two opposite sides of the insulator body 1 and configured as pillars extending along the first direction 103. Specifically, in this embodiment, the pair of holding portions 12 is disposed on two opposite ends of the base 10. In the embodiment shown in FIG. 2, the tongue plate 11 preferably protrudes beyond an end surface of the holding portion 12 in the first direction 103. In other words, when viewed from the first direction 103, the end surface of the holding portion 12 and the end surface of the tongue plate 11 are not coplanar. The partition member 14 extends along the second direction 104, which is perpendicular to the first direction 103. The partition member 14 is disposed between the two holding portions 12 and connects the pair of holding portions 12. As shown in FIG. 2, the base 10 and the tongue plate 11 are disposed on two opposite longer sides with respect to the partition member 14 and the two holding portions 12 are disposed on two opposite shorter sides with respect to the partition member 14. The grooves 13 are disposed between the holding portions 12 and extend from the base 10 through the partition member 14 to the tongue plate 11.

As shown in FIG. 2, the tongue plate 11 has a plurality of first ribs 111 extending in the first direction 103, wherein the first rib 111 defines a first groove section 131 of the respective groove 13 on the tongue plate 11. The base 10 has a plurality of second ribs 15 extending in the first direction 103 opposite to the first ribs 111. The second ribs 15 respectively correspond to the first ribs 111 and define a second groove section 132 of the respective groove 13 on the base 10. The first and second groove sections 131, 132 are separated by the partition member 14 and respectively receive the front and rear portions of the terminal 2.

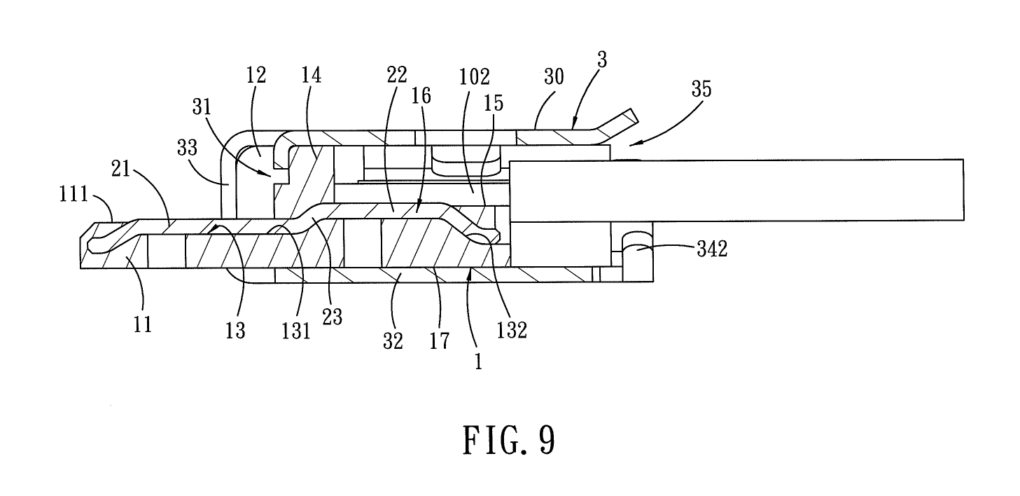

Referring to FIG. 2, the terminals 2 are inserted respectively into the grooves 13 of the insulator body 1. Each terminal 2 includes a contact portion 21 disposed on the first groove section 131, a soldering portion 22 disposed on the second groove section 132, and a connecting portion 23 connecting the contact and soldering portions 21, 22 and embedded in the partition member 14. The contact and soldering portions 21, 22 are substantially flat in shape. Preferably, the contact portion 21 and the soldering portion 22 are not located on a same plane. Specifically, as shown in FIG. 2, the contact portion 21 is disposed lower than the soldering portion 22. Preferably, each of the contact portion 21 and the soldering portion 22 has a slightly downward bent part at their distal ends (see FIG. 9). The slightly downward bent parts of the contact and soldering portions 21, 22 of each terminal 2 are accommodated respectively in the first and second groove sections 131, 132 of the respective groove 13. By means of engaging the connecting portion 23 with the partition member 14, each terminal 2 can be positioned stably in the corresponding groove 13 of the insulator body 1. It should be noted that the first ribs 111 partition the contact portions 21 of the terminals 2, while the second ribs 15 partition the soldering portions 22 of the terminals 2. Preferably, the second ribs 15 are disposed higher than the first ribs 111 according to the non-coplanar configuration of the soldering and contact portions 22 and 21 of the terminals 2.

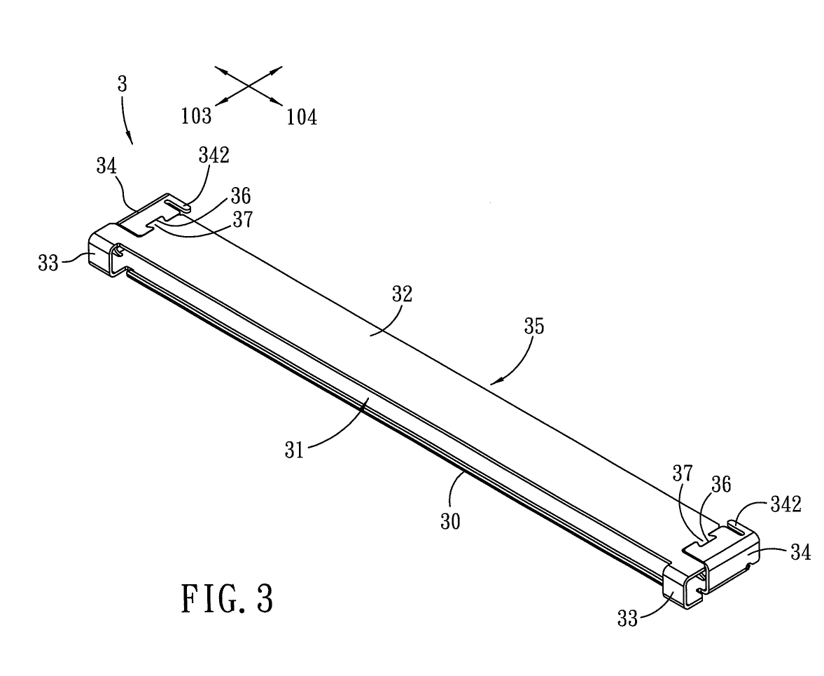

With reference to FIGS. 2 and 3, the metallic casing 3 serves as a slip-on sleeve of the insulator body 1. That is, during assembly, the insulator body can be sleeved/inserted into the metal casing 3 through its opening (i.e. the second opening 35, described later). The metallic casing 3 includes a first side plate 30, a second side plate 32 opposite to the first side plate 30, and a pair of connecting plates 33 connecting the first and second side plates 30, 32. As shown in FIG. 2, the first and second side plates 30, 32 extend along the second direction 104 and spatially overlap with each other; the connecting plates 33 connect the first and second side plates 30, 32 to form a space for accommodating the insulator body 1. Moreover, the two connecting plates 33 and the first and second side plates 30, 32 together define a first opening 31 which is open toward the first direction 103. The first opening 31 allows the tongue plate 11 to protrude therethrough as the insulator body 1 assembled with the terminals 2 is inserted into the metallic casing 3, so that the contact portions 21 of the terminals 2 are exposed from the first opening 31. The connecting plates 33 connect the first and second side plates 30, 32 at two opposite sides of the first opening 31. As the insulator body 1 assembled with the terminals 2 is inserted into the metallic casing 3 and moves toward the first opening 31, the connecting plates 33 block the holding portions 12 of the insulator body 1 to prevent the insulator body 1 from moving any further. That is, by blocking the holding portions 12 with the connecting plates 33, the insulator body 1 is substantially retained between the first and second side plates 30, 32, with the tongue plate 11 protruding out of the first opening 31. A pair of bent plates 34 connect the first and second side plates 30, 32 such that the bent plates 34 cover respectively the holding portions 12 of the insulator body 1. Specifically, the bent plate 34 covers the side surface of the holding portion 12, which is adjacent to the end surface blocked by the connecting plate 33. Each bent plate 34 has a first engaging portion 36 provided at one side thereof. The second side plate 32 has two second engaging portions 37 provided respectively at two opposite sides thereof to engage the first engaging portions 36 of the bent plates 34, respectively.

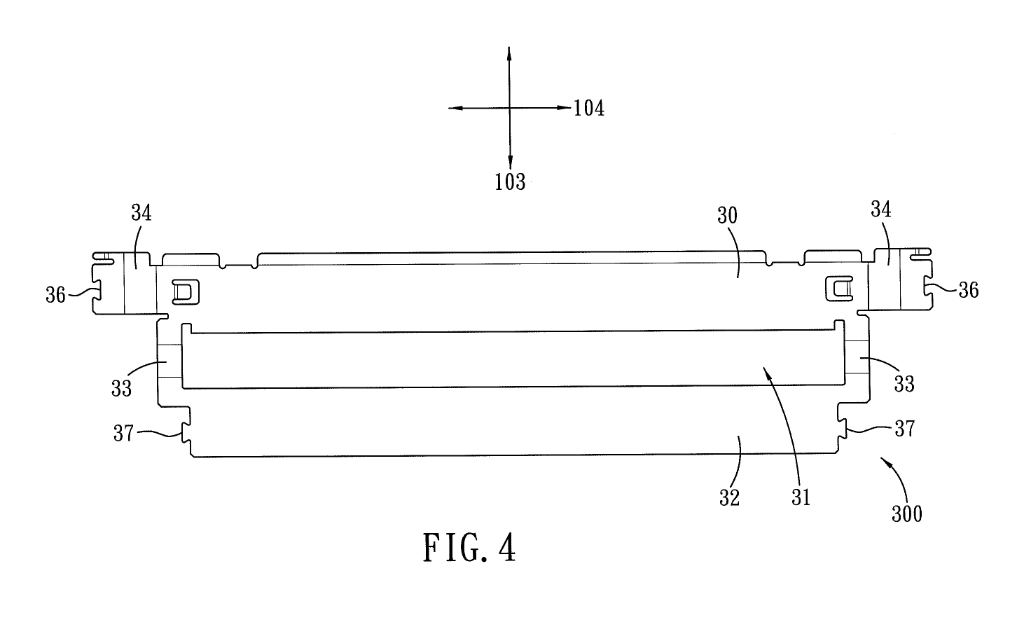

Referring to FIGS. 3 and 4, when the bent plates 34 are bent and the first engaging portions 36 are engaged with the respective second engaging portions 37, the first and second side plates 30, 32 and the connecting plates 33 together form a slip-on casing/sleeve with a rectangular cross section. As shown in FIG. 3, the bent plates 34 and the first and second side plates 30, 32 together define a second opening 35, which is opposite to and communicates with the first opening 31. In this embodiment, the metallic casing 3 is in a shape similar to a hollow hexahedron with two openings (e.g. 31, 35) on two opposite sides. That is, the first and second side plates 30, 32 substantially cover the upper side and the lower side of the base 10 and at least partially expose the tongue plate 11 and the contact portions of the terminal 2 when the insulator body 1 is inserted into the metallic casing 3 from the second opening 35 and moves toward the first opening 31. The first side plate 30 further has two resilient pieces 301 spaced apart from each other in the second direction 104. Each resilient piece 301 is formed by stamping a portion of the first side plate 30 to form a U-shaped groove or other suitable shapes of groove. Further, each bent plate 34 has a finger piece 342 proximate to the second opening 35. When the insulator body 1 is installed in the metallic casing 3, the finger pieces 342 of the bent plates 34 can bend toward the second opening 35 to prevent the holding portions 12 of the insulator body 1 from moving out of the metallic casing 3 via the second opening 35. In addition, the resilient pieces 301 also can bend toward the inner space of the metallic casing 3 to prevent the insulator body 1 from moving relative to the metallic casing 3.

Preferably, the metallic casing 3 is formed by stamping and bending a main plate. As shown in FIG. 4, a metal plate 300 for forming the metallic casing 3 is exemplarily illustrated. In this embodiment, when the main plate 300 is in an unfolded state, the first and second side plates 30, 32 are disposed side by side with the connecting plates 33 connected therebetween on two ends of the same side, i.e. the side along the second direction 104. As such, the first and side plates 30, 32 and the connecting plates 33 together enclose the first opening 31. Two bent plates 34 are connected to the two opposite edges of the first side plate 30 and extend along the second direction 104 as an extension part. In other words, the bent plates 34 protrude beyond the respective connecting plates 33. The first engaging portion 36 is formed on the distal end of the bent plate 34. The second engaging portions 37 are formed on two ends of the second side plate 32 and close to the connecting plates 33. That is, the second engaging portions 37 preferably do not extend beyond the respective connecting plates 33. Further, the first engaging portions 36 formed respectively on the bent plates 34 extend beyond the respective connecting plates 33 along the second direction 104; the second engaging portions 37 do not extend beyond the respective connecting plates 33 along the second direction 104.

After bending the flat metal plate of FIG. 4 and engaging the first engaging portions 36 with the second engaging portions 37, the metallic casing 3 can be formed. With reference to FIGS. 3 and 4, the connecting plates 33 are integrally connected to the first and second side plates 30, 32 at the two opposite sides thereof. That is, the imaginary line between the two connecting ends of the connecting plate 33 is preferably perpendicular to the longitudinal axis of the first and second side plates 30, 32 in the unfolded state and the folded state. The bent plates 34 are bent respectively from the two opposite sides of the first side plate 30 toward the second plate 32, and the first and second engaging portions 36, 37 are engaged with each other so that the first and second openings 31, 35 of the metallic casing 3 can be formed. In this embodiment, the first engaging portions 36 are preferably configured as grooves, and the second engaging portions 37 are configured as protrusions. Each of the grooves and the protrusions has a dovetail shape. In other embodiments, the positions of the grooves and the protrusions may be interchanged, and the engagement mechanism is not limited to the aforesaid disclosures. Further, the plate for forming the metallic casing 3 is not limited to a unibody structure. That is, the metallic casing 3 may be formed from bending and engaging a plurality of individual plates.

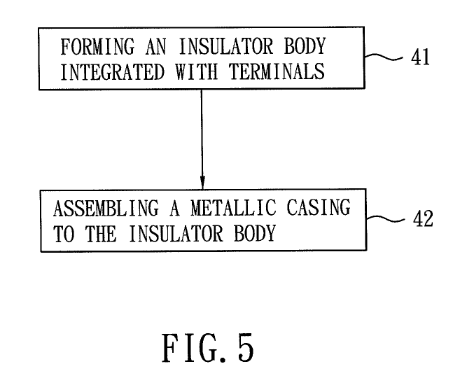

With reference to FIG. 5, a method of assembling the thin plug connector 101 is illustrated.

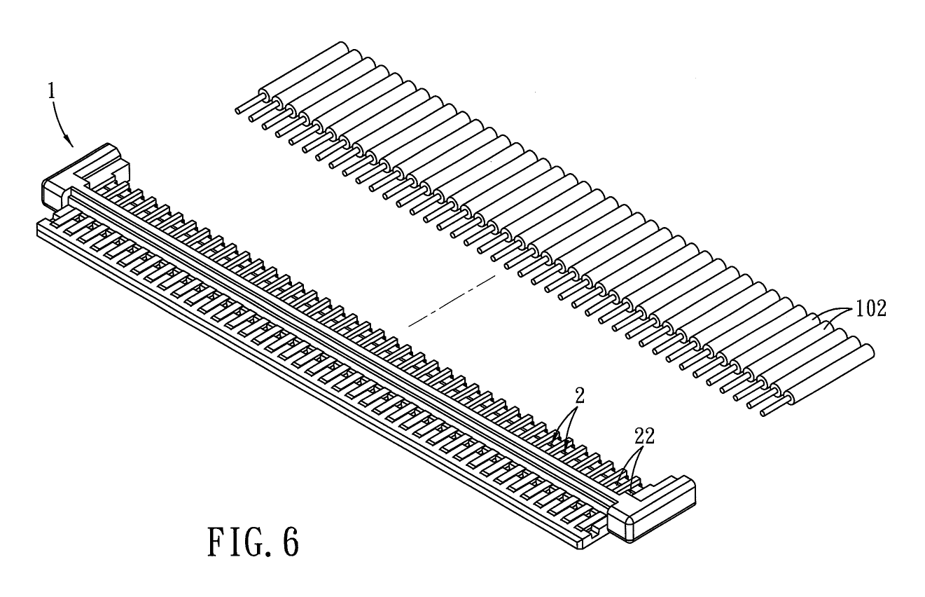

In step 41, an insulator body assembled with terminals is formed. The method of assembling the terminals 2 to the insulator body 1 may include placing the terminals 2 in a mold and using an insert molding process to form the insulator body 1, so that the terminals 2 are integrated to the insulator body 1 at the same time when the insulator body 1 is formed. Alternatively, the method of assembling the terminals 2 to the insulator body 1 may be formed by a mechanical assembling method. In this method, the insulator body 1 is first formed by an injection molding process, and then the terminals 2 are disposed respectively into the grooves 13 of the insulator body 1. After the terminals 2 are combined with the insulator body 1, the contact portions 21 of the terminals 2 are positioned on the tongue plate 11 and are separated from each other by the first ribs 111, while the soldering portions 22 of the terminals 2 are exposed on the base 10 and are separated from each other by the second ribs 15. The connecting portions 23 of the terminals 2 are embedded in or covered by the partition member 14. With reference to FIG. 6, subsequently, a plurality of cables 102 are soldered respectively to the soldering portions 22 of the terminals 2.

In this step, tin soldering wire or paste is provided on the soldering portions 22 of the terminals 2 and the second ribs 15 to form electrical connection with the cables 102. After the cables 102 and the terminals 2 are soldered, an insulating layer such as mylar is provided on the insulator body 1 to prevent the terminals 2 or the cables 102 from electrically contacting the metallic casing 3.

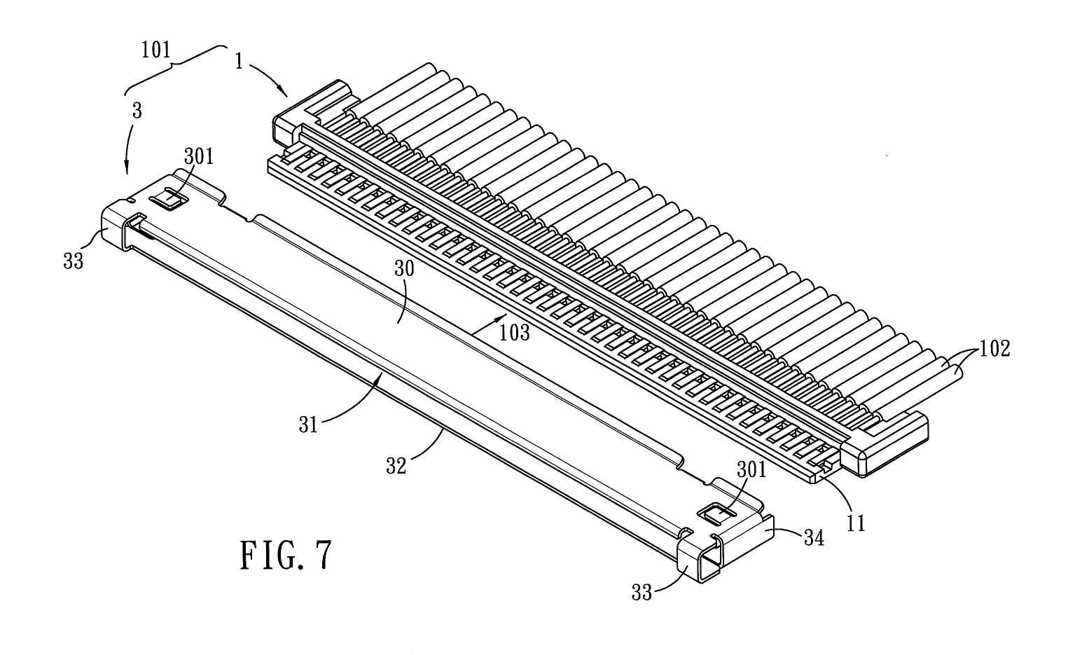

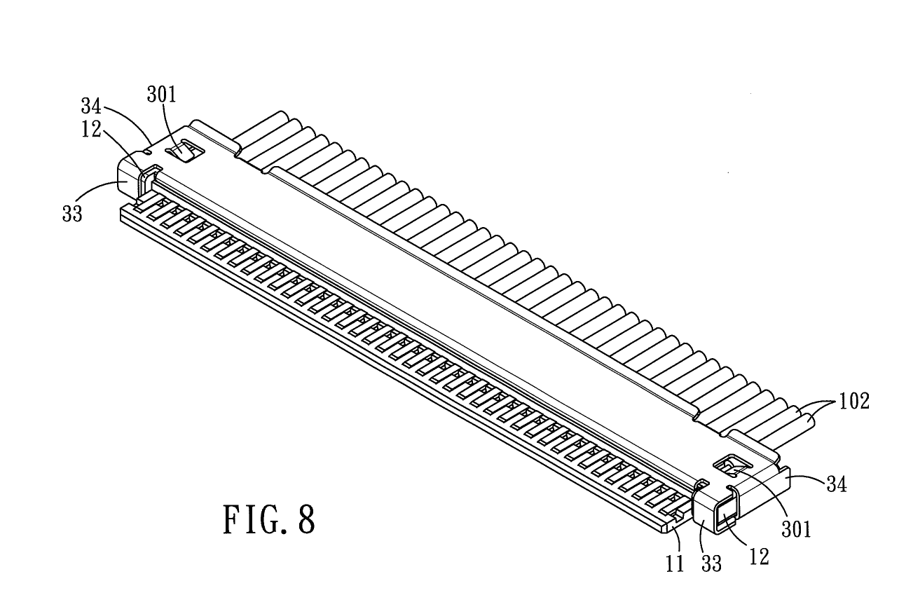

In step 42, the metallic casing 3 is assembled to the insulator body 1 such that the junctions of the cables 102 and the terminals 2 are covered by the metallic casing 3. To assemble the metallic casing 3 to the insulator body 1, the tongue plate 11 of the insulator body 1 is facing the second opening 35 of the metallic casing 3, and then the metallic casing 3 is moved toward the insulator body 1 along the first direction 103, as shown in FIG. 7. The tongue plate 11 is inserted into the metallic casing 3 from the second opening 35, passes through the space surrounded by the first and second side plates 30, 32 and the bent plates 34, and then protrudes out of the first opening 31 so as to be exposed from the metallic casing 3. When the holding portions 12 of the insulator body 1 abut against the respective connecting plates 33 of the metallic casing 3, the assembly is completed. Hence, as shown in FIGS. 8 and 9, the first and second side plates 30, 32 and the two bent plates 34 cooperatively cover the first side 16 and the second side 17 of the insulator body 1. It is noted the assembling of the metallic casing 3 and the insulator body 1 can be achieved by relatively moving the metallic casing 3 and the insulator body toward each other, so that the insulator body 1 is inserted into the metallic casing 3, which serves as a slip-on sleeve and cover most of the insulator body 1, except the tongue plate 11 as well as the contact portions 22 of the terminals 2 thereon.

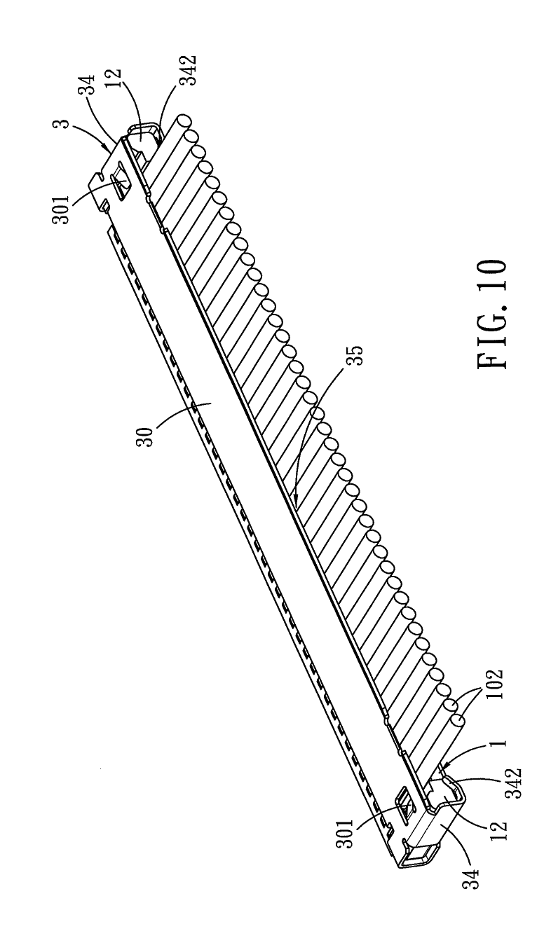

With reference to FIGS. 9 and 10, to stably install the insulator body 1 inside the metallic casing 3, the finger pieces 342 of the two bent plates 34 are bent toward the second opening 35 to prevent the insulator body 1 from moving out of the metallic casing 3 from the second opening 35. Further, the two resilient pieces 301 of the first side plate 30 are pressed downward to limit movement of the insulator body 1 relative to the metallic casing 3. Preferably, the resilient pieces 301 are pressed downward to abut respectively against shoulder portions of the holding portions 12, thereby further preventing the insulator body 1 from moving out of the metallic casing 3 from the second opening 35. Hence, additional holding force is formed to enhance the assembly stability of the metallic casing 3 and the insulator body 1.

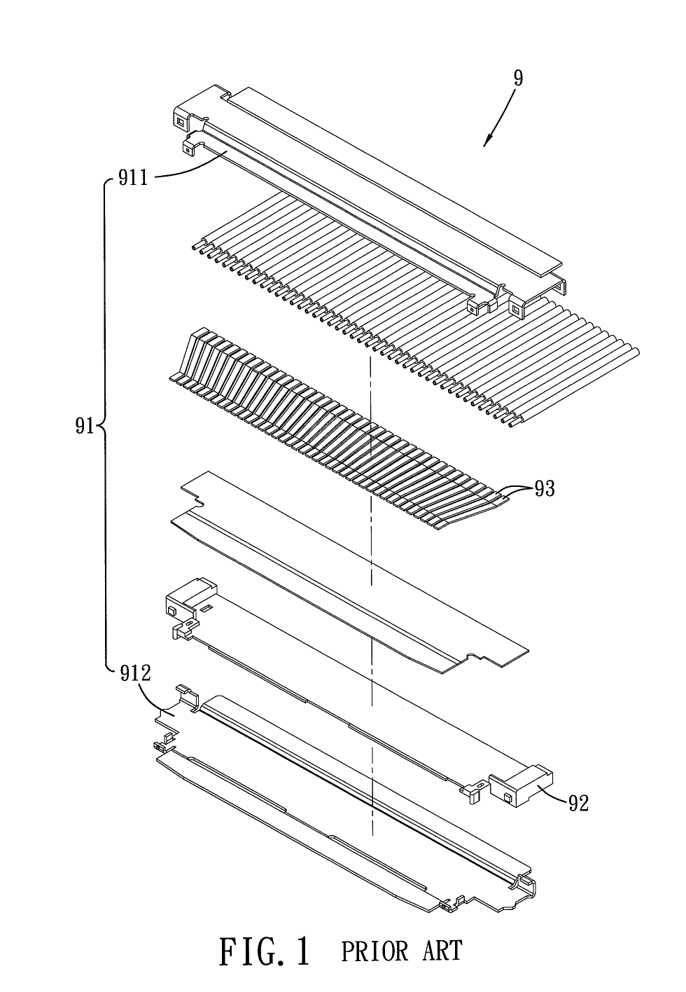

From the aforesaid description, the entire structure of the metallic casing of the present invention is preferably formed by stamping and bending a piece of flat plate, thus the structure is simple, the number of components to be assembled is less, and the assembly process is simplified, as compared to the conventional metallic casing unit 91 including the top cover 911 and the bottom cover 912 of FIG. 1.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A thin plug connector, comprising:
an insulator body including a tongue plate, a pair of holding portions, and a plurality of grooves on said tongue plate, said pair of holding portions being disposed on two opposite sides of said tongue plate;
a plurality of terminals disposed on said insulator body in said grooves, each of said terminals including a contact portion and a soldering portion, said contact portion being disposed on said tongue plate; and
a metallic casing for accommodating said insulator body, said metallic casing having a first opening, a first side plate, a second side plate opposite to said first side plate, and a connecting plate connecting said first and second side plates, said first opening permitting said tongue plate to extend out through said first opening to expose said contact portions of said terminals, said first and second side plates covering said insulator body and said soldering portions of said terminals, said connecting plate blocking said holding portions of said insulator body to restrict movement of said insulator body in a direction toward said first opening.

2. The thin plug connector of claim 1, wherein said metallic casing further comprises a pair of bent plates connecting said first and second side plates, so that said metallic casing is formed as a sleeve-like casing with a rectangular cross-section, said bent plates respectively cover said holding portions.

3. The thin plug connector of claim 2, wherein each of said bent plates has a finger piece, said finger pieces of said bent plates limit movement of said insulator body in a direction toward a second opening opposite to said first opening.

4. The thin plug connector of claim 1, wherein said metallic casing further comprises a first engaging portion and a second engaging portion, said first engaging portion is provided on said first side plate, said second engaging portion is provided on said second side plate, wherein only said first engaging portion protrudes out of said connecting plate prior to engagement of said first and second engaging portions.

5. The thin plug connector of claim 4, wherein said first and second engaging portions are configured as a groove and a protrusion to be engaged together.

6. The thin plug connector of claim 1, wherein said tongue plate has a plurality of first ribs partitioning said contact portions of said terminals, said insulator body has a plurality of second ribs partitioning said soldering portions of said terminals, and said second ribs is disposed higher than said first ribs.

7. The thin plug connector of claim 1, wherein each of said terminals further comprises a connecting portion connecting said contact portion and said soldering portion, and said connecting portion is embedded in a partition member of said insulator body.

8. The thin plug connector of claim 1, wherein the metallic casing further comprises a resilient piece formed on the first side plate, the resilient piece is bent toward the insulator body to limit movement of the insulator body relative to the metallic casing.

9. The thin plug connector of claim 1, wherein the metallic casing is an integral casing made from a flat plate.

10. A method of assembling a thin plug connector, comprising:
forming an insulator body comprising a plurality of terminals, wherein said insulator body has a tongue plate, a pair of holding portions are disposed at two opposite sides of said tongue plate, each of said terminals has a contact portion and a soldering portion, said contact portions are disposed on said tongue plate; and
installing a metallic casing on said insulator body, wherein said metallic casing has a first opening, a first side plate, a second side plate, and a pair of connecting plates, said tongue plate extends through said first opening so that said first and second side plates cover said insulator body and said soldering portions of said terminals, and said connecting plates block said holding portions of said insulator body to limit movement of said insulator body in a direction towards said first opening.

11. The method of claim 10, wherein said insulator body is formed by an insert molding process or by a mechanical assembling process.

12. The method of claim 10, further comprising electrically connecting a plurality of cables to said soldering portions of said terminals, wherein when said metallic casing is assembled to said insulator body, said cables are partially covered by said metallic casing.

13. The method of claim 10, wherein said metallic casing further comprises a second opening opposite to said first opening and a pair of bent plates covering said holding portions, said bent plates are bent toward said insulator body to block said holding portions to limit movement of said insulator body in a direction toward said second opening when said metallic casing is assembled to said insulator body.

14. The method of claim 10, wherein said metallic casing further comprises a resilient piece on said first side plate, the method further comprises pressing said resilient piece toward said insulator body when said metallic casing is assembled to said insulator body.

15. The method of claim 10, further comprising bending a flat plate to form said metallic casing.
